(19) United States
(12) Patent Application Publication
(10) Pub. No.: US 2010/0176356 A1
(43) Pub. Date: Jul. 15, 2010

(54) Manually Operated Prying Tool

(76) Inventor: Cheng-Wei SU, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/647,438

(22) Filed: Dec. 25, 2009

(30) Foreign Application Priority Data
Jan. 12, 2009 (TW) 098100961

(51) Int. Cl. B66F 15/00

(52) U.S. Cl. 254/129

(57) ABSTRACT

A manually operated prying tool comprises a prying head and a handle. The head is defined at its end with an assembling hole in which are disposed a head portion of a handle of the prying tool, a ratchet wheel, a C-shaped ring, a central shaft, a spring and a stopping piece. By pushing the central shaft, the prying tool can be switched into a fixing mode, adjustment mode, or a rotation operation mode, which allows the user to unidirectionally rotate the tool to perform micro-angle adjustment between the prying head and the handle of the prying tool, making it convenient to use the tool.

### BACKGROUND OF THE INVENTION

1. Field of the Invention

The present invention relates to a rotation control device for a manually operated prying tool.

2. Description of the Prior Art

Referring to FIGS. 1 and 2, a prying tool with an angle-adjustable prying head is disclosed in U.S. Pat. No. 7,278,626 and defined with a toothed cavity 11 in the assembling hole of its head 10. Disposed in the toothed cavity 11 are a rotary toothed block 12 and a spring 13. A prying handle 14 is defined in its head portion with a hexagonal hole 15 for engaging with the rotary toothed block 12. An operation button 16 is locked in one end of the assembling hole of the rotary toothed block 12, and then the other end of the assembling hole is sealed with a cover 17.

In normal condition, the rotary toothed block 12 is pushed by the spring 13 to engage with toothed cavity 11, so the head 10 and the prying handle 14 are fixed relative to each other, and the angle therebetween is fixed and not adjustable. When the rotary toothed block 12 is disengaged from the toothed cavity 11 by pressing the operation button 16, the head 10 can be rotated bidirectionally, and thus the angle between the head 10 and the prying handle 14 is adjustable.

When the abovementioned conventional prying tool is in use, its prying handle can be fixed or rotated with respect to the head. However, in actual practice, there is such a requirement for micro angle adjustment (such as 5 degrees) between the head and the prying handle, with the conventional structure, the user has to press the operation button and then carry out adjustment appropriately, hence, not only is it impossible for the user to handle the tool with one hand, but the user to perform such micro-angle adjustment is required to be experienced and skilled.

The present invention has arisen to mitigate and/or obviate the afore-described disadvantages.

### SUMMARY OF THE INVENTION

The primary object of the present invention is to provide a manually operated prying tool which comprises a prying head and a handle. The head is defined at its end with an assembling hole in which are disposed a head portion of a handle of the prying tool, a ratchet wheel, a C-shaped ring, a central shaft, a spring and a stopping piece. By pushing the central shaft, the prying tool can be switched into a fixing mode, adjustment mode, or a rotation operation mode, which allows the user to unidirectionally rotate the tool to perform micro-angle adjustment between the prying head and the handle of the prying tool, making it convenient to use the tool.

Hence, a manually operated prying tool is provided in accordance with the above object of the present invention and comprises a prying head and a handle. The head is defined at its end with an assembling hole in which are disposed a head portion of a handle of the prying tool, a ratchet wheel, a C-shaped ring, a central shaft, a spring and a stopping piece. The prying head is provided with a prying end at one end thereof and an assembling hole at another other end thereof, an upper assembling piece and a lower assembling piece are formed at both ends of the assembling hole, in the upper assembling piece is defined an assembling aperture, the lower assembling piece is defined with a two-step toothed groove and a through hole, the two-step toothed groove is defined with a plurality of annularly arranged bevel blocks, on a top of each of the bevel blocks is formed a bevel surface, and at a lower end of each of the bevel blocks is formed a protruding tooth, in an inner surface of the through hole is defined an annular engaging edge. T handle includes a gripping portion at one end and a head portion at the other, the head portion is formed with a ratchet hole, the head portion is disposed in the assembling hole of the prying head, and the ratchet hole is aligned and in communication with the assembling hole and the through hole. The ratchet wheel is provided with outer teeth, a central hole, and a stop flange at a lower end of an inner surface of the central hole, the ratchet wheel is inserted through the assembling aperture into the assembling hole of the prying head, and the outer teeth of the ratchet wheel are engaged with the ratchet hole of the handle and the two-step toothed groove of the prying head. The central shaft is formed with an outer annular shoulder portion, an annular protruding flange and an annular groove, the central shaft is inserted into the prying head via the assembling aperture and simultaneously into the assembling hole, the central hole of the ratchet wheel, the two-step toothed groove and the through hole. The C-shaped ring is a flexible annular structure engaged in the annular groove of the central shaft and partially protruded out of the annular groove when engaged therein. The spring is inserted through the assembling aperture onto the central shaft and has one end contacting the stop flange of the ratchet wheel. The stop piece is formed with an engaging hole and disposed in the assembling aperture, the stop piece is inserted on the central shaft via its engaging hole in such a manner that an inner end surface of the stop piece is in contact with one end of the spring, the shoulder portion of the central shaft and one end of the ratchet wheel, so as to prevent the spring, the central shaft and the ratchet wheel from disengaging from the prying head.

### BRIEF DESCRIPTION OF THE DRAWINGS

FIG. 1 is an exploded view of a prying tool disclosed in U.S. Pat. No. 7,278,626;

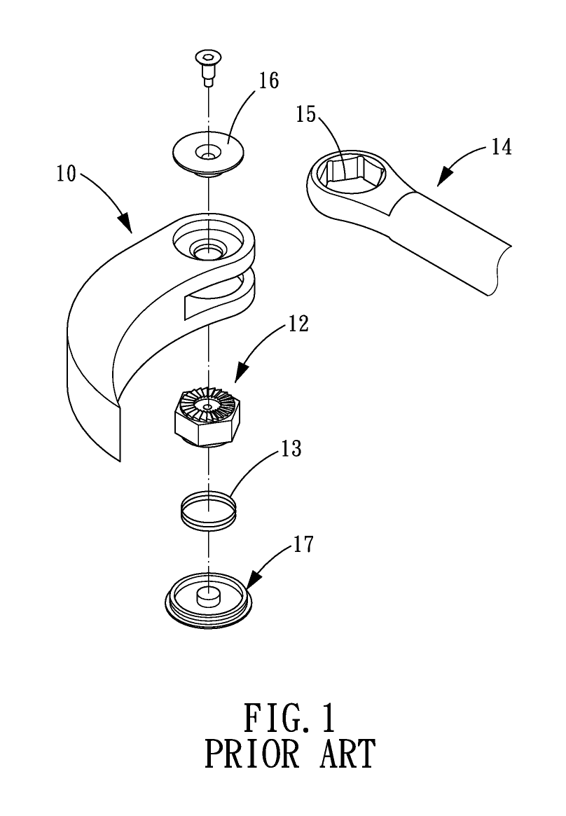

FIG. 2 is a cross sectional view of the prying tool disclosed in U.S. Pat. No. 7,278,626;

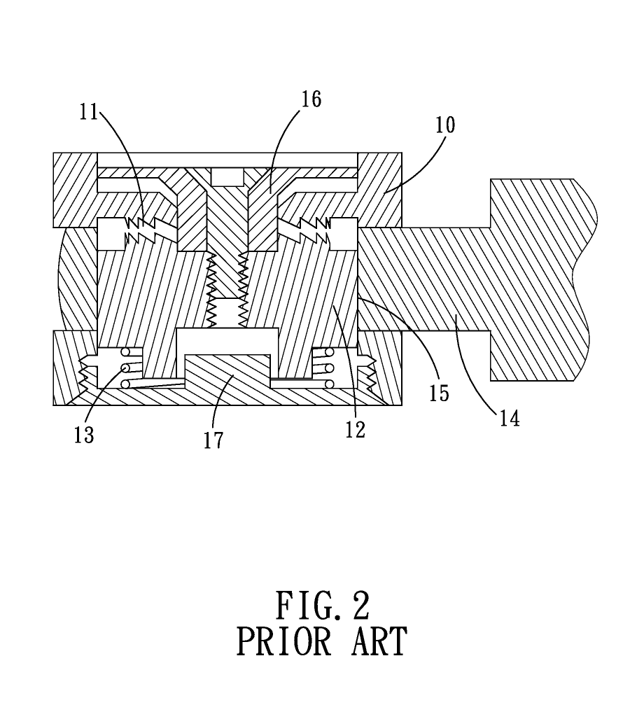

FIG. 3 is an exploded view of a prying tool in accordance with the present invention;

FIG. 4 is an amplified view of the prying tool in accordance with the present invention;

FIG. 5 is an assembly view of the prying tool in accordance with the present invention;

FIG. 6 is a cross sectional view showing that the prying tool in accordance with the present invention is set in a fixing mode;

FIG. 7 is a side view showing that the prying tool in accordance with the present invention is set in a fixing mode;

FIG. 8 is a cross sectional view showing that the prying tool in accordance with the present invention is set in an adjustment mode;

FIG. 9 is a side view showing that the prying tool in accordance with the present invention is set in an adjustment mode;

FIG. 10 is an illustrative view showing the state of the outer teeth of the ratchet wheel and the bevel surface of the bevel block of the prying head in accordance with the present invention;

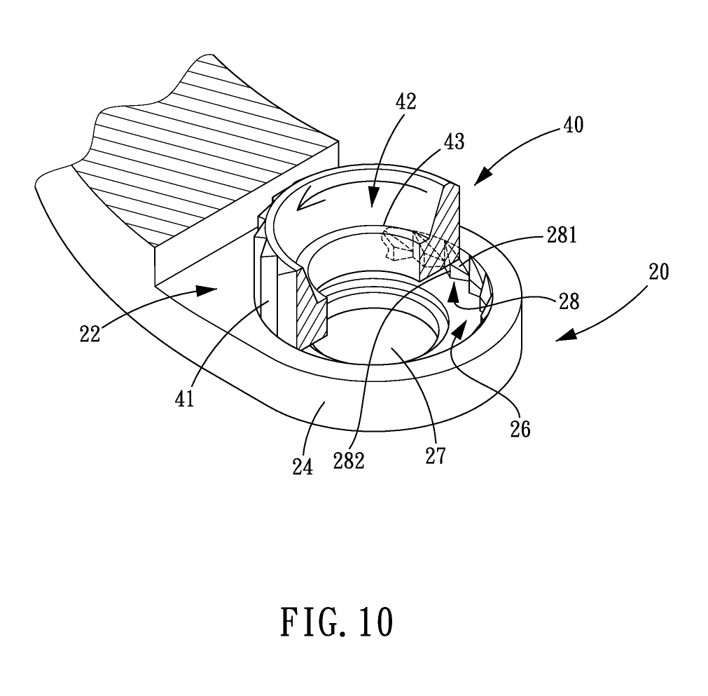

FIG. 11 is a cross sectional view showing that the prying tool in accordance with the present invention is set in a rotation mode; and

FIG. 12 is a side view showing that the prying tool in accordance with the present invention is set in a rotation mode.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

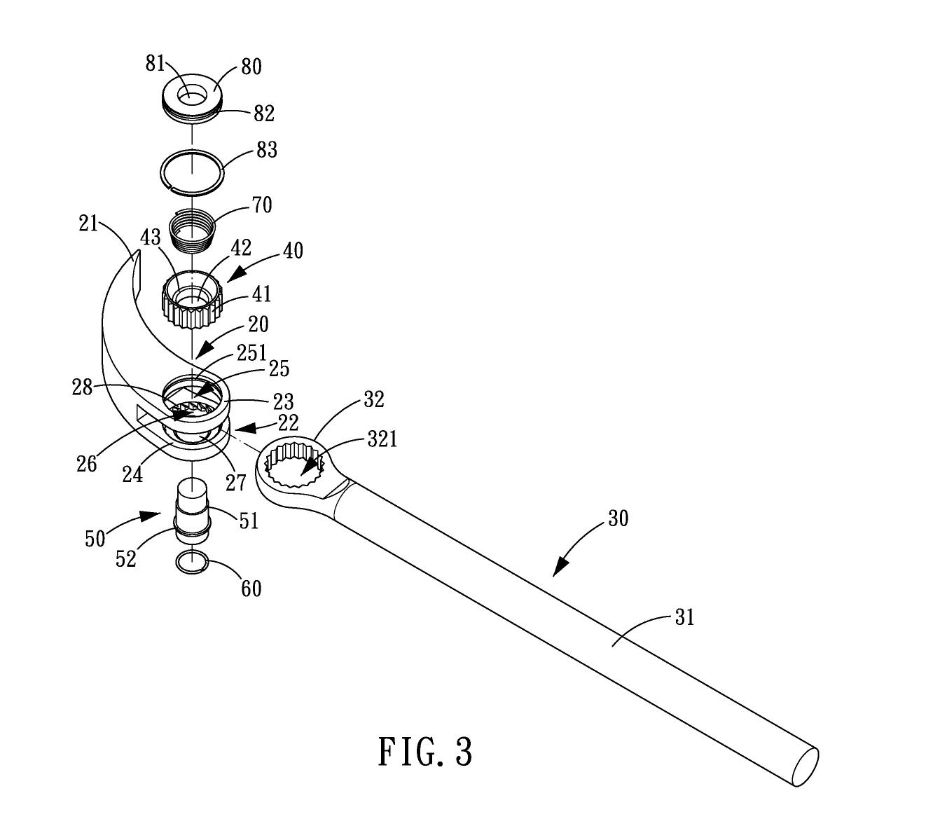

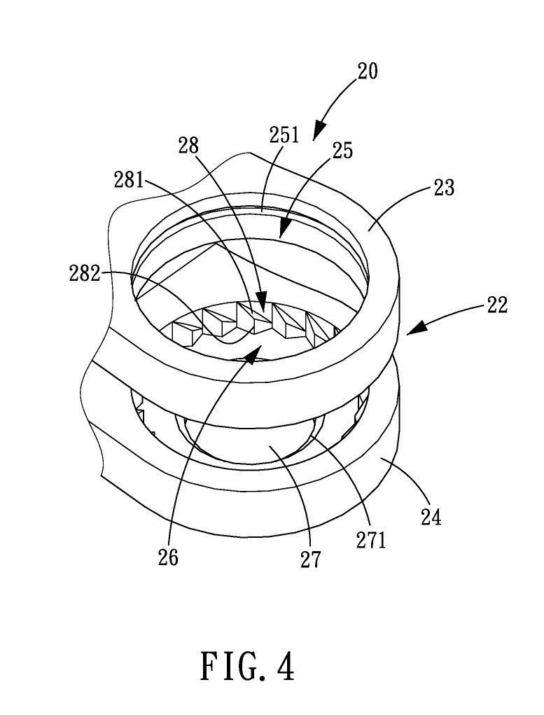

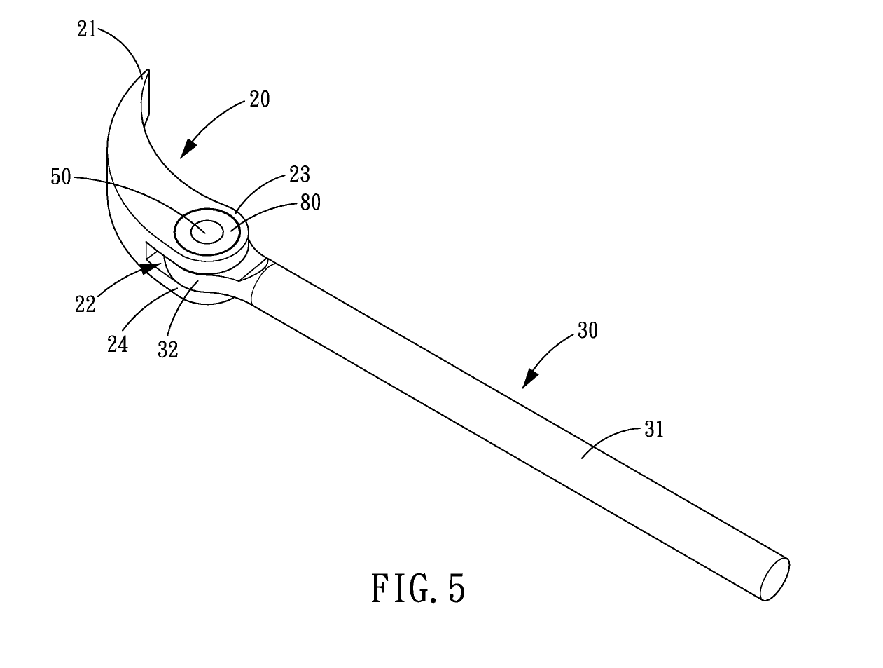

Referring to FIGS. 3-6, a manually operated prying tool in accordance with the present invention comprises a prying head 20 and a handle 30. The prying head 20 is defined at its end with an assembling hole 22 in which are disposed a head portion 32 of a handle 30 of the prying tool, a ratchet wheel 40, a C-shaped ring 60, a central shaft 50, a spring 70 and a stop piece 80.

The prying head 20 is provided with a prying end 21 at one end thereof, and the assembling hole 22 is formed at the other end of the prying head 20. Formed at both ends of the assembling hole 22 are an upper assembling piece 23 and a lower assembling piece 24, in the upper assembling piece 23 is defined an assembling aperture 25, and in the inner wall of the assembling aperture 25 is formed an annular engaging groove 251. The lower assembling piece 24 is defined with a two-step toothed groove 26 and a through hole 27. The two-step toothed groove 26 is defined with a plurality of annularly arranged bevel blocks 28, on the top of each of the bevel blocks 28 is formed a bevel surface 281, and at the lower end of each of the bevel blocks 28 is formed a protruding tooth 282. In the inner surface of the through hole 27 is defined an annular engaging edge 271.

The handle 30 includes a gripping portion 31 at one end thereof and a head portion 32 at the other. The head portion 32 is formed with a ratchet hole 321. The head portion 32 is disposed in the assembling hole 22 of the prying head 20, and the ratchet hole 321 is aligned and in communication with the assembling aperture 25 and the through hole 27.

The ratchet wheel 40 is provided with outer teeth 41, a central hole 42, and a stop flange 43 at a lower end of the inner surface of the central hole 42. The ratchet wheel 40 is inserted through the assembling aperture 25 into the assembling hole 22 of the prying head 20, and the outer teeth 41 of the ratchet wheel 40 are engaged with the ratchet hole 321 of the handle 30 and the two-step toothed groove 26 of the prying head 20.

The central shaft 50 is formed with an outer annular shoulder portion 51, an annular protruding flange 52 and an annular groove 53. The central shaft 50 is inserted into the prying head 20 via the assembling aperture 25 and simultaneously into the assembling hole 22, the central hole 42 of the ratchet wheel 40, the two-step toothed groove 26 and the through hole 27.

The C-shaped ring 60 is a flexible annular structure engaged in the annular groove 53 of the central shaft 50 and partially protrudes out of the annular groove 53 when it is engaged therein.

The spring 70 inserted through the assembling aperture 25 onto the central shaft 50 and has one end contacting the stop flange 43 of the ratchet wheel 40.

The stop piece 80 is formed with an engaging hole 81, and around the outer periphery of the stop piece 80 is formed an annular retaining groove 82. The stop piece 80 is disposed in the assembling aperture 25 and retained therein by a C-shaped retainer 83 disposed in the retaining groove 82 and the engaging groove 251. The stop piece 80 is inserted on the central shaft 50 via its engaging hole 81 in such a manner that the inner end surface of the stop piece 80 is in contact with the end of the spring 70, the shoulder portion 51 of the central shaft 50 and the end of the ratchet wheel 40, so as to prevent the spring 70, the central shaft 50 and the ratchet wheel 40 from disengaging from the prying head 20.

For a better understanding of the embodiment of the present invention, its operation and effect, reference should be made to FIGS. 3-6 again, in assembly of the prying tool, the head portion 32 of the handle 30 is inserted in the assembling hole 22 of the prying head 20, making the ratchet hole 321 aligned and in communication with the assembling aperture 25 and the through hole 27. Then the ratchet wheel 40 is inserted in the assembling hole 22 through the assembling aperture 25 of the prying head 20 in such a manner that the outer teeth 41 of the ratchet wheel 40 are engaged with the ratchet hole 321 of the handle 30 and the two-step toothed groove 26 of the prying head 20. After that, the central shaft 50 is inserted through the assembling aperture 25 into the prying head 20 and simultaneously into the assembling aperture 25, the central hole 42 of the ratchet wheel 40, the two-step toothed groove 26 and the through hole 27, and then the C-shaped ring 60 and the spring 70 are inserted onto the central shaft 50, and finally the assembly of the prying tool can be finished by sealing the assembling aperture 25 with the stop piece 80.

The prying tool of the present invention provides three operation modes, namely, the prying head and the hand of the prying tool can be fixed (fixing mode) or can rotate (rotation mode) with respect to each other, and the angle between the prying head and the handle of the prying tool can be adjusted (adjustment mode).

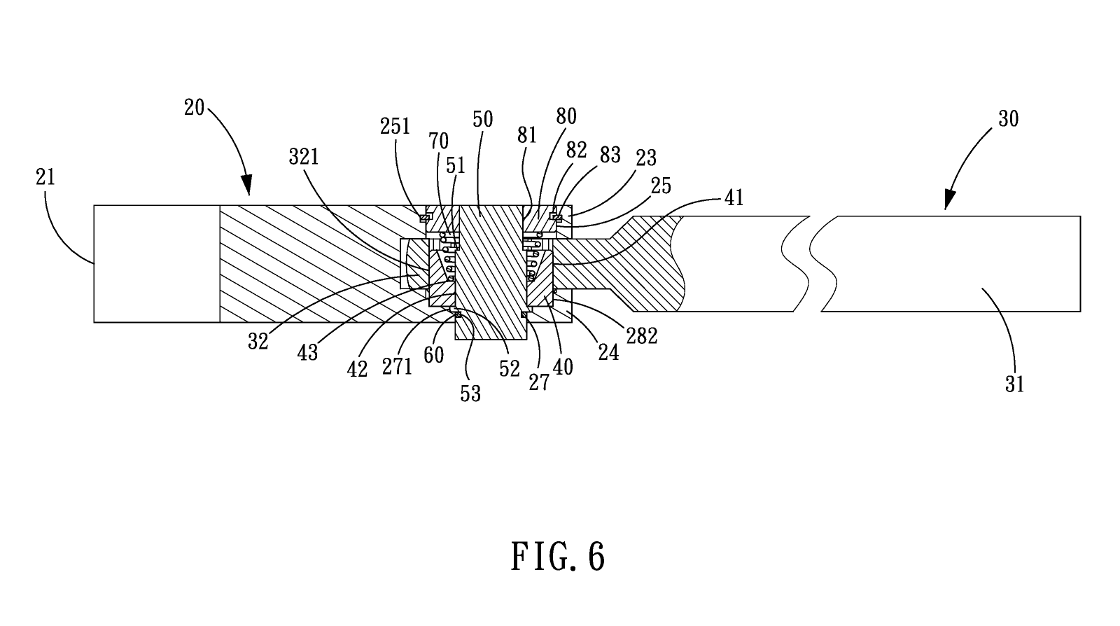

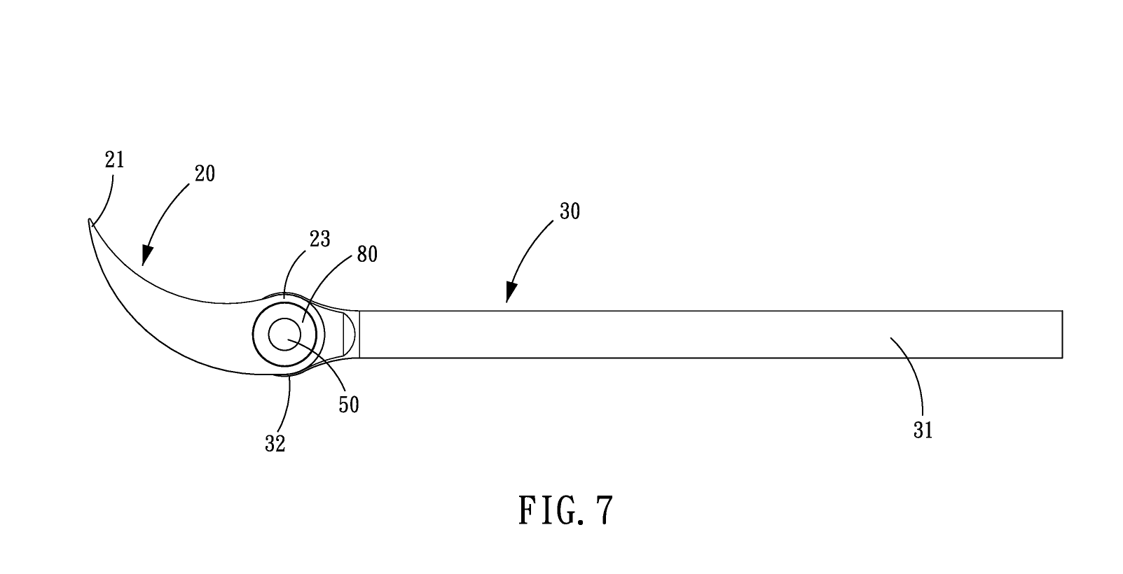

Referring to FIGS. 6 and 7, to switch the prying tool to the fixing mode, namely, to make the prying head 20 and the hand 30 of the prying tool fixed with respect to each other, the user can push the central shaft 50 toward the through hole 27 until the annular protruding flange 52 of the central shaft 50 is engaged in the annular engaging edge 271, then the prying head 20 and the hand 30 of the prying tool are fixed with respect to each other, as shown in FIG. 6. When the central shaft 50 is being pushed, the spring 70 will push the ratchet wheel 40 to make the outer teeth 41 engage with the protruding teeth 282. Meanwhile, the C-shaped ring 60 will be pushed backed into the annular groove 53 and in contact with the outer surface of he through hole 27. In the fixing mode, the ratchet wheel 40 and the prying head 20 are engaged together and not allowed to rotate relative to each other, and the handle 30 is also engaged with the prying head 20, at this state, the prying tool can be used to perform prying tasks.

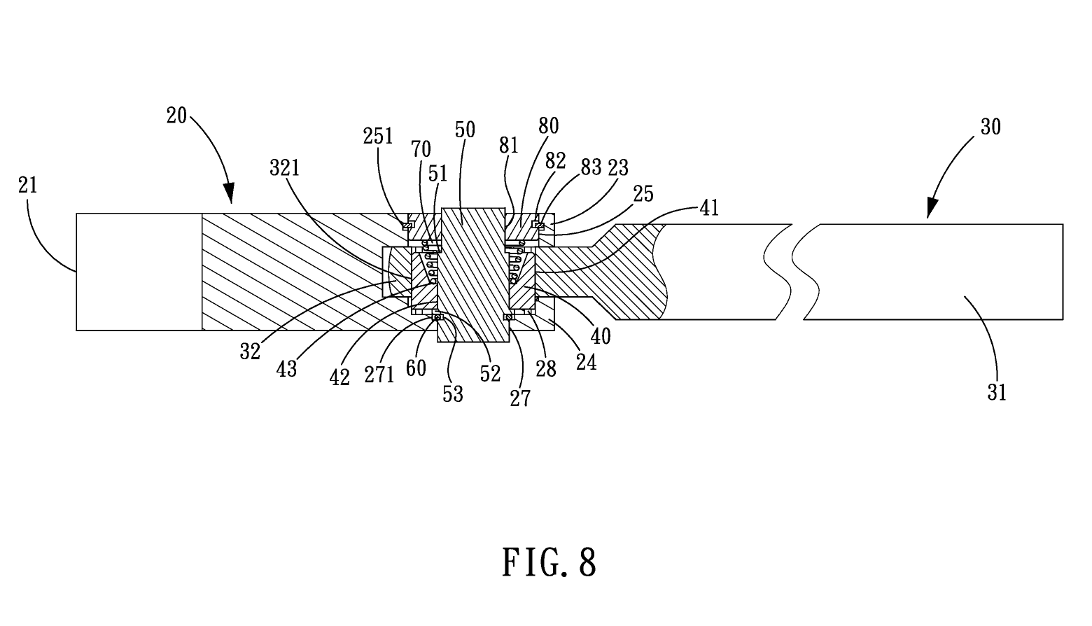

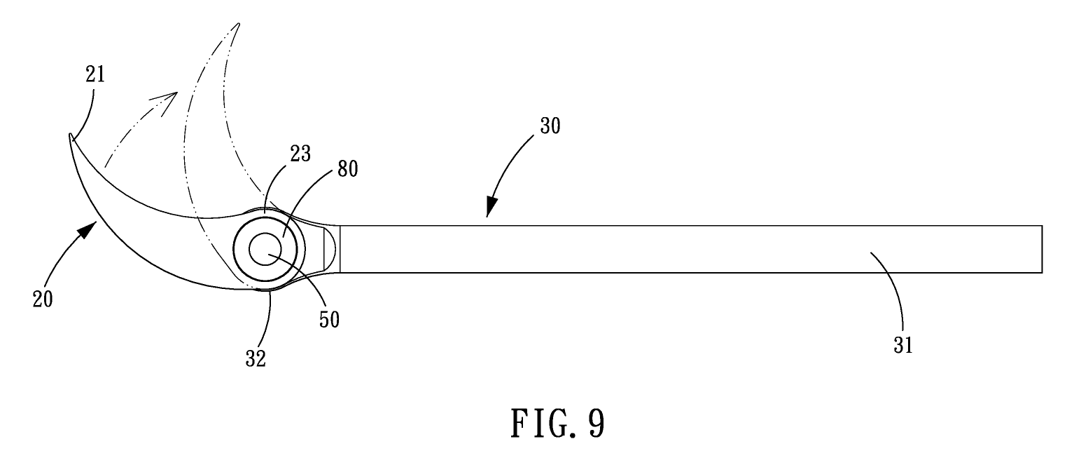

Referring then to FIGS. 8 and 9, to switch the prying tool to the adjustment mode, namely, to adjust the angle between the prying head 20 and the handle 30, the user can push the central shaft 50 toward the assembling aperture 25 until the C-shaped ring 60 is engaged in the annular engaging edge 271, at this moment, the outer teeth 41 of the ratchet wheel 40 are engaged with the lower end of the bevel surface 281 of the bevel blocks 28, which means that the ratchet wheel 40 and the prying head 20 are in partial engagement with each other, so that the user can rotate the prying head 20 unidirectionally. During rotation, (for easy description, only one outer tooth 41 is described) the tooth 41 of the ratchet wheel 40 moves upward toward the assembling aperture 25 from the lower end of the bevel surface 281 of one bevel block 28, when it moves to the top end of the bevel surface 281 of the bevel block 28, the travel for one-tooth-angle adjustment has been finished and the outer tooth 41 will move back down to the lower end of the bevel surface 281 of the next bevel block 28, and thus one-tooth-angle adjusted is completed, and by repeating the above operation, the angle between the prying head 20 and the handle 30 is adjusted.

It is to be noted that, in normal conditions, the prying tool can preferably be set in the adjustment mode, so that the user can easily unidirectionally rotate the prying head 20 so as to perform micro-angle or large-angle adjustment between the prying head 20 and the handle 30. Unlike the conventional structure, the angle adjustment of the present invention doesn't require the user to press the button with the other hand, furthermore, the adjustment mode of the present invention allows the angle of the prying head 20 to be adjusted in an angel by angle manner, and hence, it is a more precise angle adjustment than the conventional structure.

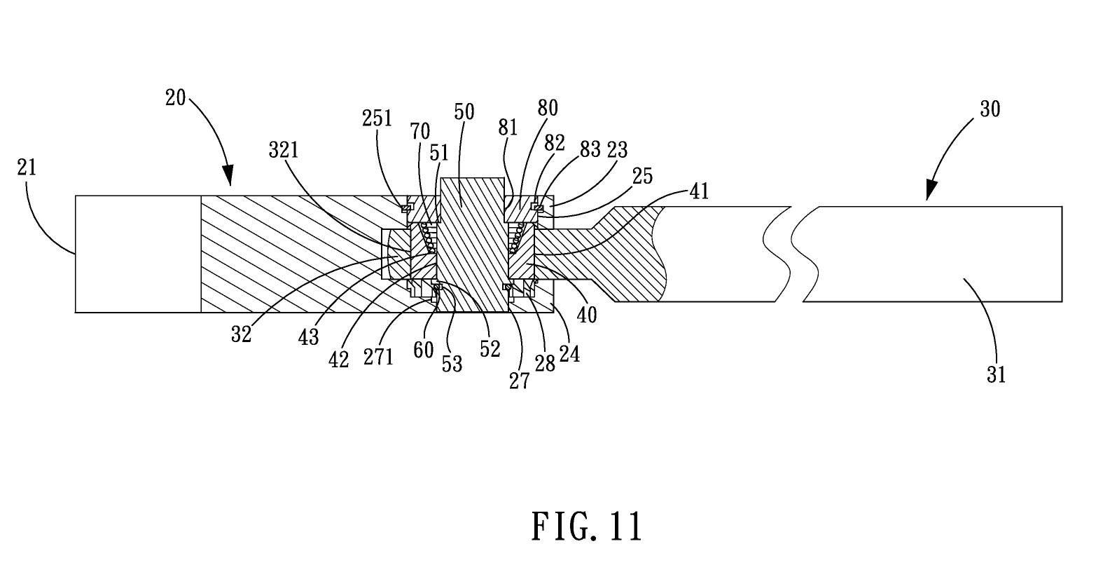

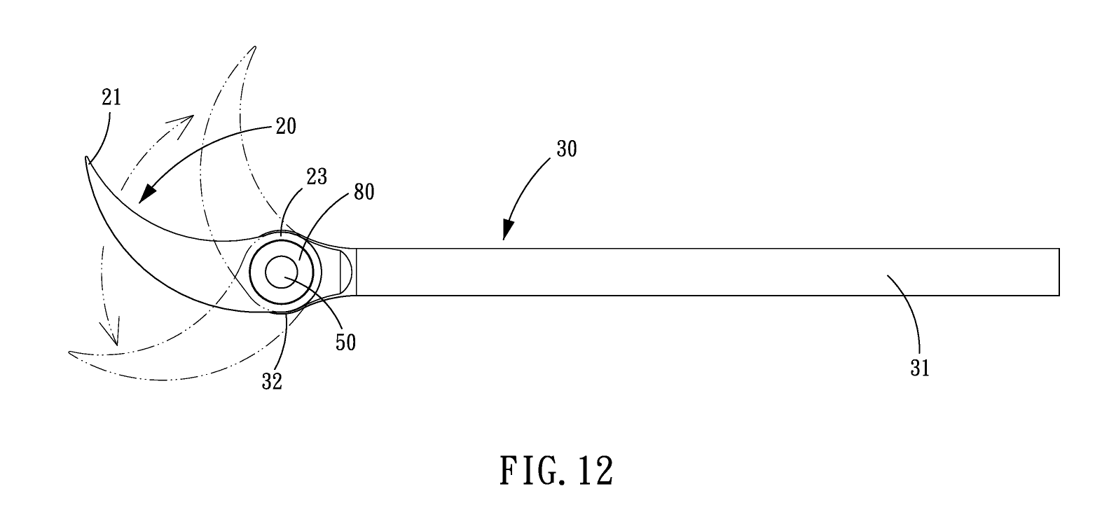

Referring finally to FIGS. 11 and 12, to switch the prying tool into the rotation mode, the user can push the central shaft 50 toward the assembling aperture 25 until the shoulder portion 51 of the central shaft 50 abuts against the stop piece 80, and thus the prying tool is switched into the rotation mode. At this moment, the outer teeth 41 of the ratchet wheel 40 will move out of contact with the bevel blocks 28. In this rotation mode, the ratchet wheel 40 and the prying head 20 are disengaged from each other, so that the user can rotate the prying head 20 bidirectionally, in other words, it allows a bidirectional angle adjustment between the prying head 20 and the handle 30.

While we have shown and described various embodiments in accordance with the present invention, it is clear to those skilled in the art that further embodiments may be made without departing from the scope of the present invention.

What is claimed is:

1. A manually operated prying tool comprising:
a prying head provided with a prying end at one end thereof and an assembling hole at another other end thereof, an upper assembling piece and a lower assembling piece being formed at both ends of the assembling hole, in the upper assembling piece being defined an assembling aperture, the lower assembling piece being defined with a two-step toothed groove and a through hole, the two-step toothed groove being defined with a plurality of annularly arranged bevel blocks, on a top of each of the bevel blocks being formed a bevel surface, and at a lower end of each of the bevel blocks being formed a protruding tooth, in an inner surface of the through hole being defined an annular engaging edge;
a handle including a gripping portion at one end and a head portion at the other, the head portion being formed with a ratchet hole, the head portion being disposed in the assembling hole of the prying head, and the ratchet hole being aligned and in communication with the assembling hole and the through hole;
a ratchet wheel provided with outer teeth, a central hole, and a stop flange at a lower end of an inner surface of the central hole, the ratchet wheel being inserted through the assembling aperture into the assembling hole of the prying head, and the outer teeth of the ratchet wheel being engaged with the ratchet hole of the handle and the two-step toothed groove of the prying head;
a central shaft formed with an outer annular shoulder portion, an annular protruding flange and an annular groove, the central shaft being inserted into the prying head via the assembling aperture and simultaneously into the assembling hole, the central hole of the ratchet wheel, the two-step toothed groove and the through hole;
a C-shaped ring being a flexible annular structure engaged in the annular groove of the central shaft and partially protruded out of the annular groove when engaged therein;
a spring inserted through the assembling aperture onto the central shaft and having one end contacting the stop flange of the ratchet wheel;
a stop piece being formed with an engaging hole and disposed in the assembling aperture, the stop piece being inserted on the central shaft via its engaging hole in such a manner that an inner end surface of the stop piece is in contact with one end of the spring, the shoulder portion of the central shaft and one end of the ratchet wheel, so as to prevent the spring, the central shaft and the ratchet wheel from disengaging from the prying head.

2. The manually operated prying head as claimed in claim 1, wherein an annular engaging groove is formed in an inner wall of the assembling aperture of the prying head, around an outer periphery of the stop piece is formed an annular retaining groove, the stop piece is disposed in the assembling aperture and retained therein by a C-shaped retainer disposed in the retaining groove of the stop piece and the engaging groove of the prying head.
